(19) United States
(12) Patent Application Publication
(10) Pub. No.: US 2012/0147080 A1
(43) Pub. Date: Jun. 14, 2012

(54) INKJET PRINTER

(75) Inventor: Takeshi Kodaira, Nagano (JP)

(73) Assignee: MIMAKI ENGINEERING CO., LTD., NAGANO (JP)

(21) Appl. No.: 13/391,820

(22) PCT Filed: Aug. 26, 2010
(86) PCT No.: PCT/JP2010/005280

§ 371 Date: Feb. 23, 2012

(30) Foreign Application Priority Data
Aug. 26, 2009 (JP) 2009-195808

(51) Int. Cl. B41J 29/38

(52) U.S. Cl. 347/17

(57) ABSTRACT

Disclosed is an inkjet printer. The inkjet printer comprises a carriage that has a print head that discharges ink; a carriage-moving mechanism that moves the carriage relatively along the surface to be printed of the printing medium that is supported by a platen; a print heater that heats the platen to adjust the heat of the printing medium; a non-contact temperature sensor that is attached to the carriage opposite the surface to be printed and that, along with the relative motion due to the carriage, detects the surface temperature of the printing medium along the direction of the abovementioned relative motion; and a temperature control unit of a control unit and an SSR that perform adjustment control of the surface temperature of the printing medium to a predetermined set temperature by means of driving the print heater on the basis of the detected temperature from the non-contact temperature sensor.

### TECHNICAL FIELD

The present invention relates to an inkjet printer that prints information, such as, text, drawings, patterns, and pictures on a printing surface of a printing medium by causing minute droplets of ink from nozzles to be deposited on the printing medium while moving a carriage having a printer head with the nozzles arranged therein relative to the printing medium supported by a medium supporting unit.

### BACKGROUND ART

Because such inkjet printers have a configuration that causes minute droplets of ink in liquid form to be deposited on a printing medium to produce drawings with high precision, there is a need to perform temperature control in an area where the drawing is formed not only on the side of a printer head but also on the side of the printing medium. Furthermore, to ensure high quality printing and high productivity, it is necessary that the ink that is deposited on the printing medium be fixed and dried as quickly as possible.

In view of the above discussion, conventional inkjet printers are provided with a heater that heats up a platen, which in turn heats up the printing medium, and a thermistor (temperature detecting unit) that detects the temperature of the heated platen. The platen is maintained at a constant temperature based on a temperature deviation between the detected temperature of the platen and a desired temperature of the platen set by an operator (for example, see Patent Document 1).

### CONVENTIONAL ART DOCUMENTS

### Patent Documents

Patent Document 1: Japanese Patent Application Laid-open No. H11-20144

### DISCLOSURE OF INVENTION

### Problem to be Solved by the Invention

However, in the conventional inkjet printer described above, in spite of the platen being adjusted to the desired temperature, a deviation occurs between the temperature of the platen and the temperature on the surface of the printing medium depending on the type of the printing medium and the ink used or due to a difference in the thermal conductivities of the printing medium and the platen. That is, no temperature control of the surface temperature of the printing medium, which is heated up by thermal conduction from the platen, is performed. Therefore, depending on the surface temperature of the printing medium, the ink may exhibit poor fixability leading to running of the ink and color variability. This can eventually lead to reduced printing quality.

The present invention is made in view of the problem described above and it is an object of the present invention to provide an inkjet printer that has a configuration that enables adjustment of the surface temperature of the printing medium to an optimum temperature to facilitate adherence of the ink.

### Means to Solve the Problems

To achieve the above objects, an inkjet printer according to an aspect of the present invention includes a medium supporting unit (for example, a platen 10 in the embodiments) that supports a printing medium; a carriage that includes a printer head that discharges ink; a carriage moving mechanism that moves the carriage relative to the printing medium supported by the medium supporting unit along a printing surface thereof; a heater unit (for example, a print heater 70 in the embodiments) that performs heating temperature control of the printing medium; a temperature detecting unit (for example, a non-contact temperature sensor 80 in the embodiments) that is mounted on the carriage facing the printing surface and that detects a surface temperature of the printing medium along a relative movement direction with the relative movement of the carriage; and a temperature control unit (for example, a temperature control unit 106 and an SSR 90 of a control unit 100 in the embodiments) that exerts control to adjust the surface temperature of the printing medium to a predetermined setting temperature by driving the heater unit based on a detected temperature detected by the temperature detecting unit.

In the inkjet printer according to the above aspect of the present invention, it is preferable that the heater unit includes a plurality of segment heater units (for example, print heaters 71 to 75 in the embodiments) that performs heating temperature control of the printing medium, which is segmented into a plurality of segmented areas along the relative movement direction, segmented area by segmented area, and the temperature control unit (for example, a temperature control unit 106′ and SSRs 91 to 95 in the embodiments) drives an appropriate segment heater unit based on the detected temperature detected segmented area by segmented area by the temperature detecting unit along the relative movement direction, and exerts control to homogenize the surface temperature of the printing medium to a predetermined setting temperature.

In the inkjet printer according to the above aspect of the present invention, it is preferable that the temperature control unit exerts control to adjust the surface temperature of a segmented areas where a discharge amount of the ink deposited thereon exceeds a predetermined threshold value set in the printer head to a temperature obtained by adding a heating amount according to the discharge amount to the predetermined setting temperature.

### Advantages of the Invention

In an inkjet printer according to an aspect of the present invention, a temperature detecting unit detects a surface temperature of a printing medium along a relative movement direction with a relative movement of a carriage by a carriage moving mechanism. Consequently, feedback control can be performed, based on a temperature detected by the temperature detecting unit, by driving a heater unit so as to adjust the surface temperature of the printing medium to a predetermined setting temperature. Consequently, over-adjustment of the temperature to correct the discrepancy between the surface temperature of the printing medium and the temperature of the medium supporting unit can be avoided. In addition, by keeping the printing medium adjusted to the predetermined setting temperature at all times, fixability of the ink discharged from a printer head onto the printing medium can be improved, and printing on the printing medium can be carried out with high precision. The inkjet printer according to the present invention is particularly advantageous in cases where there is a significant discrepancy between the temperature of the printing medium and the temperature of the medium supporting unit, for example, when the printing medium is thick or when there is a significant difference between the thermal conductivities of the printing medium and the medium supporting unit.

It is desirable that the heater unit be a segmented heater unit that performs heating temperature control of the printing medium, which is segmented along the relative movement direction of the carriage into a plurality of areas, area by area. With this structure, the surface temperature is detected by the temperature detecting unit for each segmented area of the segmented heater unit, and feedback control can be performed, based on the temperature detected by the temperature detecting unit, by driving the heater unit so as to homogenize a surface temperature distribution of the printing medium to the predetermined setting temperature. Consequently, because the surface temperature across the entire drawing area of the printing medium can be homogenized, fixability of the ink discharged from the printer head onto the printing medium can be stabilized without any unevenness across the entire drawing area, and thus a printing quality can be further improved.

Furthermore, it is desirable that a temperature control unit exert control to adjust the surface temperature of the segmented area where a discharge amount of the ink deposited thereon exceeds a predetermined threshold value set in the printer head to a temperature obtained by adding a heating amount according to an ink discharge amount to the predetermined setting temperature. With this structure, in the portions of the printing medium M where an ink deposition amount is more, the ink is quickly fixed and dried, and thereby high quality printing and better productivity can be realized. Furthermore, by pre-heating the printing medium by the heating amount according to the ink discharge amount, the setting temperature of the portion of the printing medium M where the ink deposition amount is less can be kept relatively low. Consequently, energy saving can be realized by reducing power consumption.

### BRIEF DESCRIPTION OF DRAWINGS

FIG. 1 is an oblique front perspective view of an inkjet printer to which the present invention is applied.

FIG. 2 is an oblique rear perspective view of the inkjet printer shown in FIG. 1.

FIG. 3 is a front view of a configuration of relevant parts in a main apparatus unit of the inkjet printer shown in FIG. 1.

FIG. 4 is a schematic side-cross-sectional view of the inkjet printer viewed at a position of and from the direction of an arrow V shown in FIG. 1.

FIG. 5 is a schematic front-cross-sectional view of a platen included in the inkjet printer according to a first embodiment of the present invention.

FIG. 6 is a schematic block diagram of the inkjet printer according to the first embodiment.

FIG. 7 is a schematic front-cross-sectional view of a platen included in an inkjet printer according to a second embodiment of the present invention.

FIG. 8 is a schematic block diagram of the inkjet printer according to the second embodiment.

FIG. 9 is a schematic side-cross-sectional view of an inkjet printer according to a third embodiment of the present invention viewed at a position of and from the direction of the arrow V shown in from FIG. 1.

FIG. 10 is a schematic block diagram of the inkjet printer according to the third embodiment.

FIG. 11 is a schematic front view showing a modification of a heater unit included in the inkjet printer.

### BEST MODE(S) FOR CARRYING OUT THE INVENTION

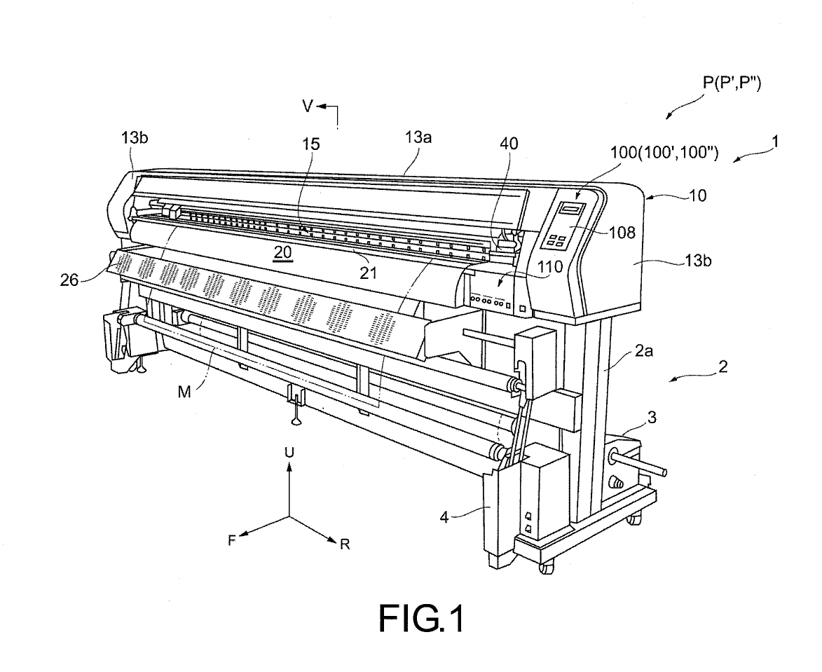

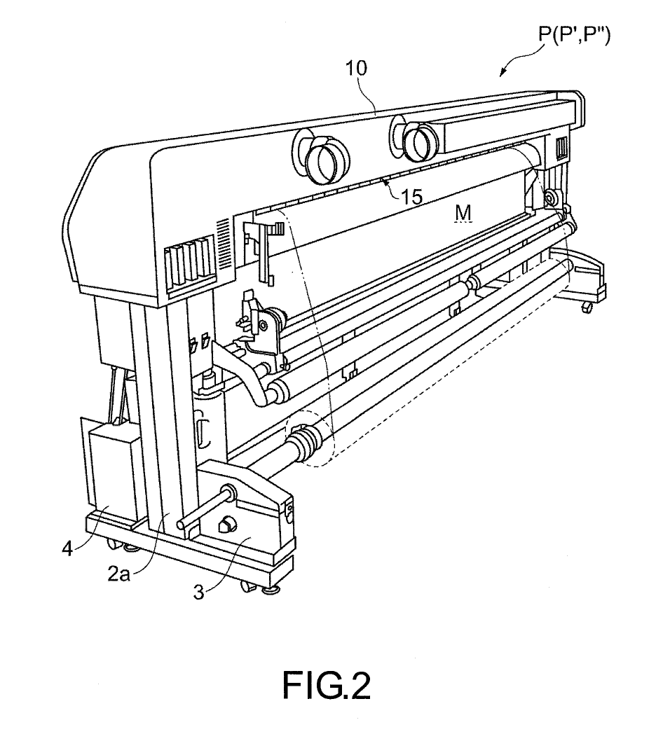

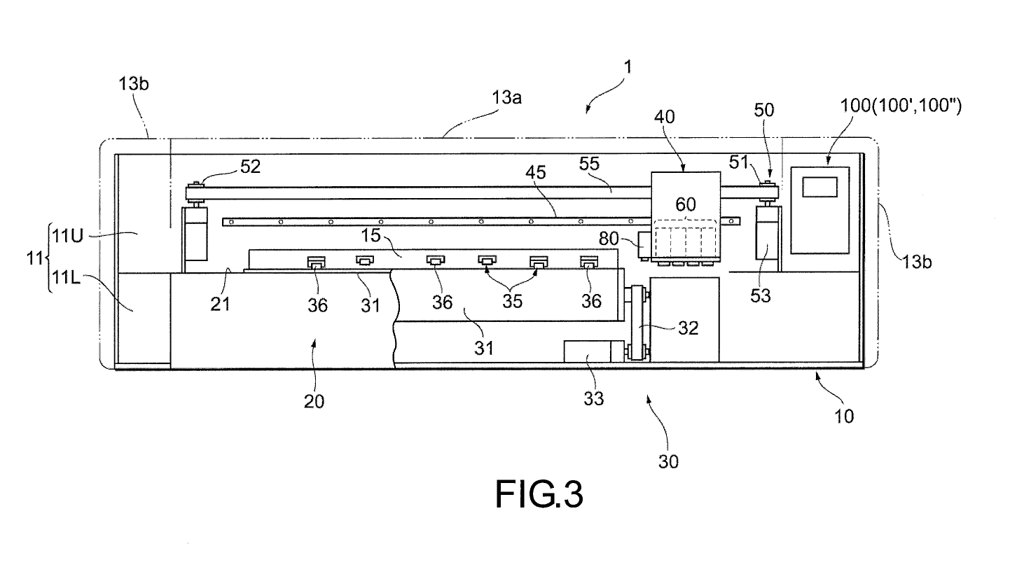

Three exemplary embodiments of the present invention are explained in detail below with reference to the accompanying drawings. The present invention is applied to an inkjet printer, as an example, in which, of the two axes X and Y, the movement of a printing medium occurs along one axis and the movement of a printer head occurs along the other axis. FIG. 1 is an oblique front perspective view of the inkjet printer. FIG. 2 is an oblique rear perspective view of the inkjet printer. FIG. 3 depicts relevant parts in a main apparatus unit of the inkjet printer. An overall configuration of the inkjet printer is explained with reference to FIGS. 1 to 3. In the following explanation, arrows F, R and U of FIG. 1 represent a forward direction, a rightward direction, and an upward direction, respectively.

### First Embodiment

An inkjet printer P according to the first embodiment broadly includes a main apparatus unit 1 that has a laterally long, box-like structure and that performs printing of text, figures, etc., on a printing surface of a sheet-type PVC printing medium M, and a supporting member 2 that supports and elevates the main apparatus unit 1 to a height convenient for operation. The inkjet printer P further includes a feeding mechanism 3 that feeds blank printing medium M rolled on a roller that is arranged near left and right leg members 2a that constitute the supporting member 2, and a winding mechanism 4 that winds the printing medium M after printing has been performed thereon.

The main apparatus unit 1 primarily includes a body 10 that functions as a base on which various mechanisms are mounted, a platen 20 that supports the printing medium M, a medium moving mechanism 30 that moves the printing medium M supported by the platen 20 back and forth, a carriage 40 that is arranged above the platen 20 and supported to be movable horizontally, a carriage moving mechanism 50 that moves the carriage 40 horizontally relative to the printing medium M supported by the platen 20, a plurality of printer heads 60 carried in the carriage 40 such that the printer heads 60 are separated from the printing surface of the printing medium M by a predetermined gap, and a control unit 100 that controls operations of all parts of the inkjet printer P, such as, back and forth movement of the printing medium M by the medium moving mechanism 30, the horizontal movement of the carriage 40 by the carriage moving mechanism 50, and discharge of the ink from each nozzle of the printer heads 60.

The body 10 includes a main frame 11 that in turn includes a lower frame 11L, and an upper frame 11U. The platen 20 and a feed roller 31 of the medium moving mechanism 30 are arranged on the lower frame 11L. A roller assembly 35 of the medium moving mechanism 30 and a supporting mechanism of the carriage 40 are arranged on the upper frame 11U. A laterally long, window-like printing medium passageway 15 through which the printing medium M can be moved back and forth is formed between the upper frame 11U and the lower frame 11L. The body 10 has a front cover 13a covering a mid portion of the main frame 11 and side covers 13b covering the left and the right sides of the main frame 11, thus forming a laterally long, box-like structure.

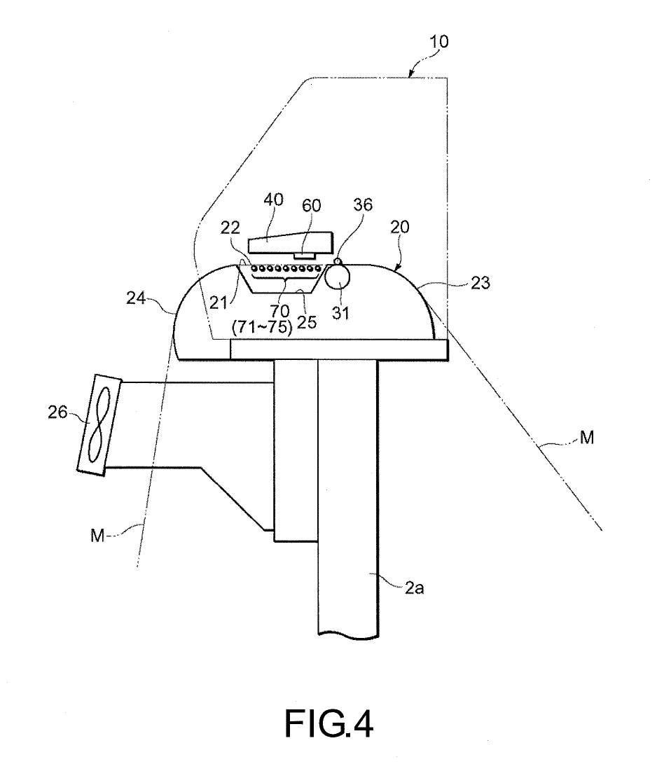

The platen 20 is arranged on the lower frame 11L horizontally centrally in the body 10, extending anteroposteriorly below the printing medium passageway 15. A medium supporting unit 21 that evenly supports the printing medium M is formed in a horizontal strip of a drawing area corresponding to the printer heads 60. Furthermore, as shown in FIG. 4, which is a schematic side-cross-sectional view of the inkjet printer P viewed at a position of and from the direction of an arrow V shown in FIG. 1, the platen 20 includes a main platen 22 on which the medium supporting unit 21 is formed, a rear platen 23 that extends backward from the main platen 22 and that is arranged on a back face of the body 10, and a front platen 24 that extends forward from the main platen 22 and that is arranged on a front end face of the body 10. The rear end of the rear platen 23 and the front end of the front platen 24 are gently curved downward to facilitate the printing medium M that is guided to the platen 20 from the feeding mechanism 3 to smoothly move over the surfaces of the rear platen 23, the main platen 22, and the front platen 24 and be wound by the winding mechanism 4. A plurality of fans 26 that blow air into a sheet discharge area of the printing medium M and facilitate the ink deposited on the printing medium M to dry is arranged at substantially equal intervals below the front platen 24 in the front thereof (front sheet discharge area).

A plurality of small diameter suction holes is formed in the medium supporting unit 21 of the main platen 22. A decompression chamber 25 that can be set to a negative pressure is provided below the suction holes. By setting the decompression chamber 25 to a negative pressure, the printing medium M can be held against the medium supporting unit 21 by suction, ensuring that the printing medium M does not move when the printing process or a cutting process is underway.

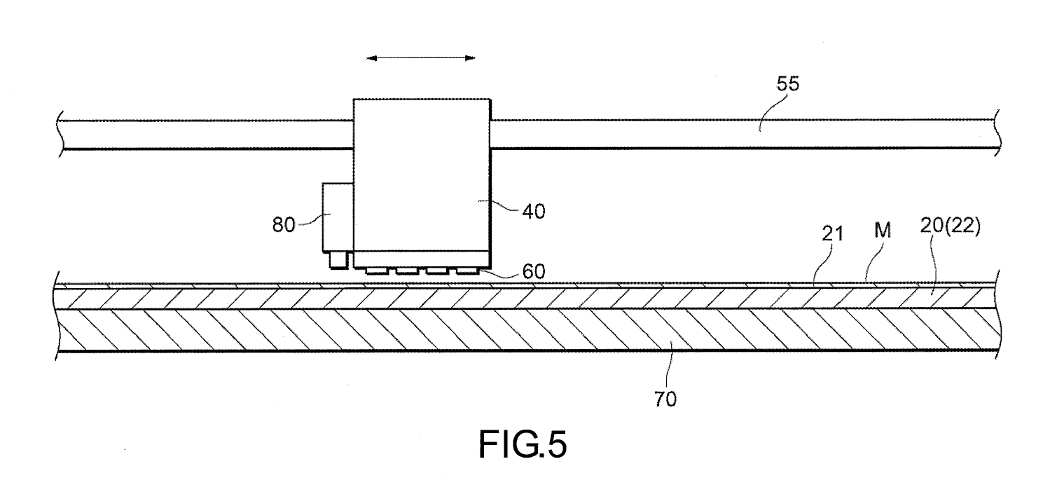

Furthermore, as shown in FIG. 5, which is a schematic front-cross-sectional view of the platen 20, a print heater (electric heater) 70 that improves fixability of the ink droplets discharged from the printer heads 60 by heating up substantially the entire drawing area of the printing medium M supported by the medium supporting unit 21 is built into a back face of the main platen 22.

The medium moving mechanism 30 primarily includes the cylindrical feed roller 31, which is rotatable about a rotation axis that extends horizontally, with an upper periphery thereof exposed to the medium supporting unit 21, a servo motor 33 that rotation drives the feed roller 31, a timing belt 32 that is stretched between a driven pulley coupled to an axis end of the feed roller 31 and a driving pulley coupled to an axis end of the servo motor 33, and a plurality of roller assemblies 35 each of which has a pinch roller 36 arranged before and after it and arranged horizontally at predetermined intervals above the feed roller 31.

The roller assembly 35 can be set to a clamped position or an unclamped position. In the clamped position, the pinch roller 36 is elastically engaged to the feed roller 31, whereas in the unclamped position, the pinch roller 36 rests above the feed roller 31 with a gap therebetween. In the clamped position of the roller assembly 35, and with the printing medium M clamped between the upper and lower rollers 36 and 31, the printing medium M is fed back and forth by a feed amount corresponding to a rotation angle of the feed roller 31 by rotation driving the servo motor 33, that is, by a feed amount corresponding to a drive control value output from the control unit 100 to the servo motor 33. Both the clamped position and the unclamped position of the roller assembly 35 are shown in FIG. 3.

A guide rail 45 that extends horizontally and is parallel to the feed roller 31 is mounted on the upper frame 11U located above the printing medium passageway 15. The carriage 40 that carries the printer heads 60 is supported by the guide rail 45 so as to be movable horizontally. The guide rail 45 is a support rail with a linear motion bearing, and is also referred to as a linear motion guide or linear guide. The carriage 40 is fixed to a slide block (also referred to as a ball housing, or the like) which is fitted to and supported by the guide rail 45 and, in this manner, the carriage 40 is supported above the platen 20 so as to be slidable horizontally and is moved horizontally by the carriage moving mechanism 50 as described below.

The carriage moving mechanism 50 includes a driving pulley 51 and a driven pulley 52 which are respectively provided near the right and left side ends of the guide rail 45, a servo motor 53 for rotationally driving the driving pulley 51, an endless timing belt 55 which is stretched over the driving pulley 51 and the driven pulley 52, etc. The carriage 40 is connected and fixed to the timing belt 55. Rotation of the servo motor 53 is controlled by the control unit 100 and the carriage 40 is moved horizontally by the feed amounts corresponding to the drive control values output from the control unit 100 to the servo motor 53.

The printer heads 60 are provided on an under face of the carriage 40 so as to be separated from the printing medium M by the predetermined gap. The printer heads 60 can be arranged in various arrangement configurations and an arrangement configuration that is appropriate for the purpose may be used. In the present embodiment, as one example, a large number of nozzles from which minute ink droplets are discharged are linearly arranged anteroposteriorly to form two parallel nozzle rows. Four printer heads 60 having the two nozzle rows each are arranged horizontally to form an arrangement of a total of eight nozzle rows.

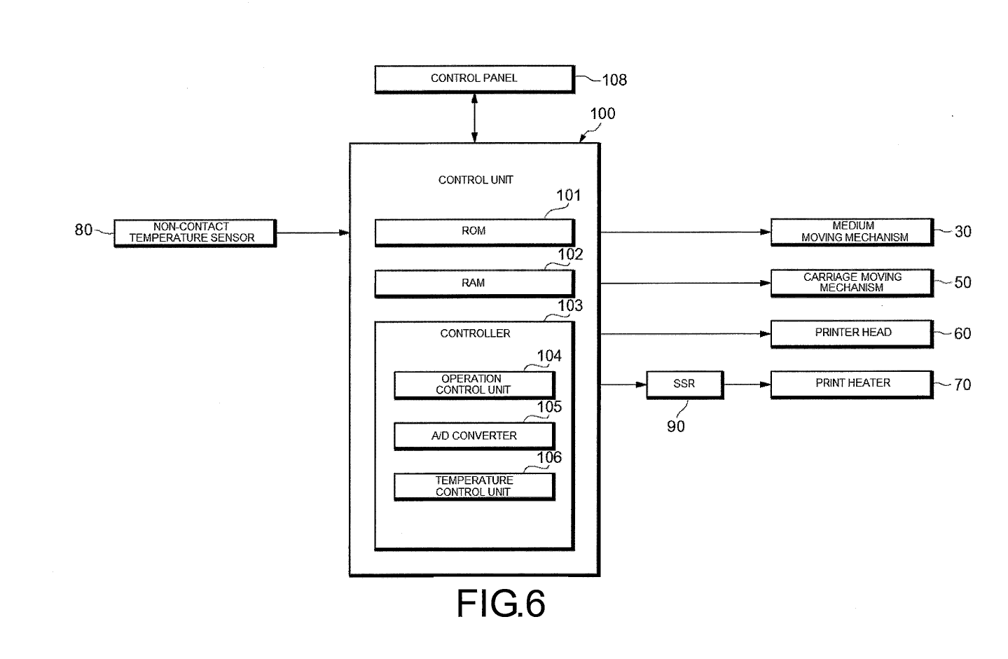

A schematic block diagram of the inkjet printer P is shown in FIG. 6. The control unit 100 includes a ROM 101 onto which operation control computer programs for controlling operations of respective parts of the inkjet printer P and a temperature control computer program, which is explained later, for controlling the surface temperature of the printing medium M are written, a RAM 102 that temporarily stores therein printing computer programs, etc., for drawing on the printing medium M, a controller 103 that executes arithmetic processing based on the printing computer program read from the RAM 102 or an operation signal input through an operation panel 108 and controls the operations of the respective parts according to the control computer program, and the operation panel 108 that includes a display panel that displays an operating condition, etc., and various operation switches. The control unit 100 exerts control to move the printing medium M and the printer heads 60 relative to each other by combining the back and forth movement of the printing medium M by the medium moving mechanism 30 and the horizontal movement of the carriage 40 by the carriage moving mechanism 50, and discharge of ink from the respective nozzles of the printer heads 60, etc., to draw information according to the printing computer program.

The control unit 100 is provided on the top right of the body 10. The operation panel 108, which is operable from the front of the body, includes a liquid crystal display that displays various types of information, and various operation buttons, such as, function keys for selecting functions for setting, a jog key for selecting execution of the selection, an enter key for entering the selection, and a clear key for canceling the selection. This enables an operator to make settings of the print heater 70 and printing conditions while viewing the settings on the liquid crystal display, and execute the printing process.

A heater panel 110 that displays a status of the print heater 70 built into the platen 20 is arranged below the control unit 100 (operation panel 108). An optimum temperature of the printing medium M (an optimum surface temperature of the printing medium M to facilitate the ink droplets to adhere to the printing surface) can be set using the operation panel 108. The value of the setting temperature (optimum temperature) that is set using the operation panel 108 is stored in the RAM 102 provided in the control unit 100. The optimum temperature of the printing medium M can be set suitably according to a material of the printing medium M, a type of the ink being used, the thermal conductivity of the platen 20, surrounding atmospheric conditions, etc.

The inkjet printer P has a heater control function for adjusting the surface temperature of the printing medium M to the setting temperature (optimum temperature). A control structure for realizing the heater control function includes, as shown in FIG. 6, a non-contact temperature sensor 80 that detects the surface temperature of the printing medium M, the controller 103 of the control unit 100, and an SSR 90 that is electrically connected between the control unit 100 and the print heater 70 and that drives the print heater 70.

The non-contact temperature sensor 80 is a radiation thermometer that measures the surface temperature of the printing medium M by detecting a strength of the infrared rays (infrared energy) emanating from a measurement target surface (printing surface of the printing medium M), and is fitted on a side face of the carriage 40 with a detecting face thereof facing the printing surface of the printing medium M. The non-contact temperature sensor (radiation thermometer) 80 generally has a high response speed, and is capable of measuring the surface temperature of the printing medium M, that is, the measurement target surface, definitively and accurately even when the carriage 40 moves at a high speed. Furthermore, the non-contact temperature sensor 80 detects the infrared rays emanating from the printing medium M as it is moved horizontally (scanning movement) by the carriage moving mechanism 50 at equal but very short time intervals, and sequentially outputs analog voltage signals corresponding to the strength of the detected infrared rays to the control unit 100.

The controller 103 of the control unit 100 includes an operation control unit 104 that controls the driving of the medium moving mechanism 30, the carriage moving mechanism 50, etc., and the discharge of the ink droplets from the printer heads 60, an A/D converter (analog to digital converting unit) 105 explained next, and a temperature control unit 106.

The A/D converter 105 converts the analog voltage signals that are input from the non-contact temperature sensor 80 to digital signals (digital values).

The temperature control unit 106 converts the output value (digital value) output from time to time from the A/D converter 105 into a detected temperature Tm, calculates the temperature deviation ΔT (=Ts−Tm), based on the detected temperature Tm and a setting temperature (optimum temperature) Ts already set in the RAM 102, and outputs a driving signal corresponding to the temperature deviation ΔT to the SSR 90. The detected temperature Tm, for example, is an average value (or a maximum value or a minimum value, etc.) of the surface temperatures (detected temperatures) of the respective positions of the printing medium M that are sequentially input at very short time intervals from the non-contact temperature sensor 80 during one pass (one way) scanning movement by the carriage moving mechanism 50 that is formed integrally with the carriage 40, during a predetermined printing operation.

The SSR (Solid State Relay) 90 is a non-contact type heater driving device, and exerts control over the driving of the print heater 70 so as to adjust the surface temperature of the printing medium M to the setting temperature Ts by performing switch driving of the print heater 70 based on the driving signal (driving amount corresponding to the temperature deviation ΔT) output from the temperature control unit 106 and thereby switching the power supply to the print heater 70 on or off (power supplied/power supply cut off).

In this manner, the temperature control unit 106 compares the setting temperature Ts of the printing medium M set in the RAM 102 and the detected temperature Tm of the non-contact temperature sensor 80, and performs feedback control by switching the power supply to the print heater 70 on or off via the SSR 90 to adjust the surface temperature of the printing medium M to the optimum temperature (setting temperature Ts).

An overall structure of the inkjet printer P according to the first embodiment has been described above. Operations of the constituent components of the inkjet printer P by which desirable printing is carried out on the printing medium M are explained below.

The printing medium M on which printing is to be performed is set in the inkjet printer P so as to be fed forward from the back over the platen 20 by the turning of the feed roller 31 while being clamped between the upper and lower rollers 36 and 31. When the printing medium M is being fed, the carriage 40 is moved back and forth horizontally along the guide rail 45 over the printing medium M held against the platen 20 by the carriage moving mechanism 50, and the ink droplets are discharged from the nozzles on the under faces of the printer heads 60 onto the printing medium M to be deposited thereon in a desired pattern. The printing medium M is then fed forward by a predetermined pitch, and once again the carriage 40 is moved back and forth horizontally to repeat discharge of the ink droplets from the nozzles of the printer heads 60.

During the printing operation of the inkjet printer P, the non-contact temperature sensor 80 built integrally into the carriage 40 moves scanningly over the printing medium M and detects the infrared rays emanating from the printing medium M at very short time intervals, and sequentially outputs the detection signals corresponding to the strength of the detected infrared rays to the control unit 100. The analog signals input from the non-contact temperature sensor 80 are converted into digital signals by the A/D converter 105 in the control unit 100, and thereafter function-converted into the detected temperature Tm by the temperature control unit 106. The temperature control unit 106 compares the measured detected temperature (average value of the surface temperature of the printing medium M) Tm and the setting temperature Ts (optimum temperature of the printing medium M) already stored in the RAM 102, and calculates the temperature deviation ΔT thereof.

The temperature control unit 106 then outputs the driving signal corresponding to the magnitude of the temperature deviation ΔT to the SSR 90, and thereby controls the switching on or off of the power supply to the print heater 70. When the power supply is switched on, during the period in which power is supplied to the print heater 70, the printing medium M gets heated up via the platen 20, and the surface temperature of the printing medium M rises gradually. When the power supply is switched off, during the period in which power supply to the print heater 70 is cut off, no heating of the platen 20 and the printing medium M takes place, and the surface temperature of the printing medium M gradually declines. Thus, by controlling the switching on or off of the power supply to the print heater 70 according to the magnitude of the temperature deviation ΔT, the surface temperature of the printing medium M in the drawing area can be adjusted to the setting temperature Ts.

Each time the non-contact temperature sensor 80 moves scanningly over the printing medium M along with the carriage 40, the surface temperature of the printing medium M in the area thereof that has been fed forward by the predetermined pitch is also measured, and based on the temperature deviation ΔT from the detected temperature Tm in this area, control of the switching on or off of the power supply to the print heater 70 is performed so that the surface temperature of the printing medium M is adjusted to the setting temperature Ts. Therefore, even as the printing medium M is continually fed forward as the scanning movement of the carriage 40 is underway, the surface temperature of the printing medium M can be maintained at the optimum temperature at all times.

The advantages of the inkjet printer P according to the first embodiment are summarized below. The inkjet printer P determines the temperature deviation ΔT from the setting temperature Ts based on the detected temperature Tm measured (actual measurement) by the non-contact temperature sensor 80 at the same time when the printing operation is performed by the printer heads 60, and performs feedback control by switching the power supply to the print heater 70 on or off so that the surface temperature of the printing medium M is at the optimum temperature. Consequently, over-adjustment of the temperature to correct the discrepancy between the surface temperature of the printing medium M and the temperature of the platen 20 can be avoided. In addition, because the surface temperature of the printing medium M can be maintained at the desired optimum temperature at all times, the fixability of the ink discharged from the printer heads 60 can be stabilized well, and thus the printing quality of the inkjet printer P can be improved.

### Second Embodiment

An inkjet printer P′ according to a second embodiment of the present invention is shown in FIGS. 1 and 2. The inkjet printer P′ has a structure that is substantially similar to that of the inkjet printer P according to the first embodiment. Only the aspects in which the inkjet printer P′ differs from the inkjet printer P are explained below. The constituent elements of the inkjet printer P′ that have been assigned the same reference numerals/symbols as for the inkjet printer P have the same structures explained in the first embodiment.

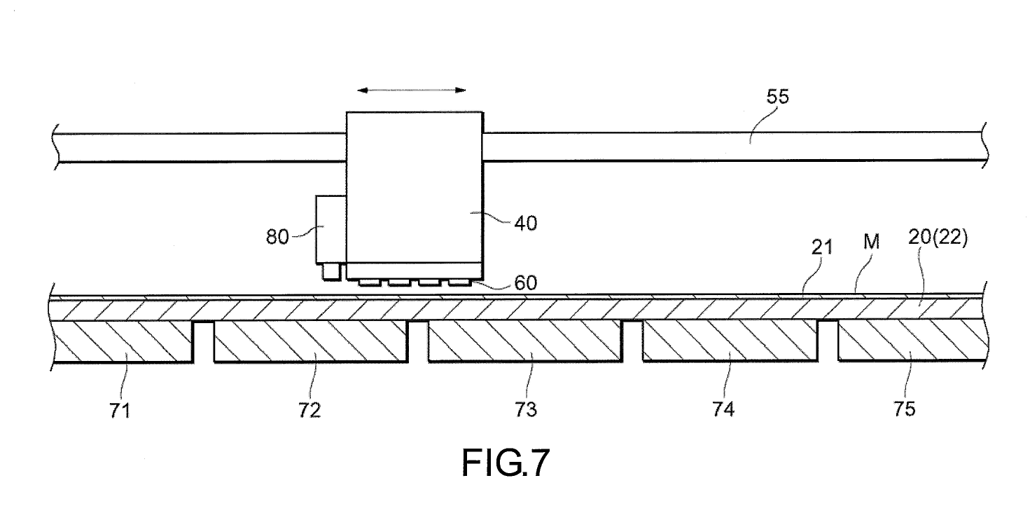

In the second embodiment, as shown in FIG. 7, which is a schematic front-cross-sectional view of the platen 20, a plurality of print heaters 71 to 75 is arranged in a scanning direction (horizontal direction) of the carriage 40 on the back face of the main platen 22 that supports the printing medium M on which printing is to be performed. In response to a command output from a temperature control unit 106′ of a control unit 100′, the power supply to each of the print heaters 71 to 75 is controlled so as to be independently switched on or off via a corresponding one of SSRs 91 to 95. Although five print heaters 71 to 75 are presented here as an example, the number thereof can be four or less or six or more.

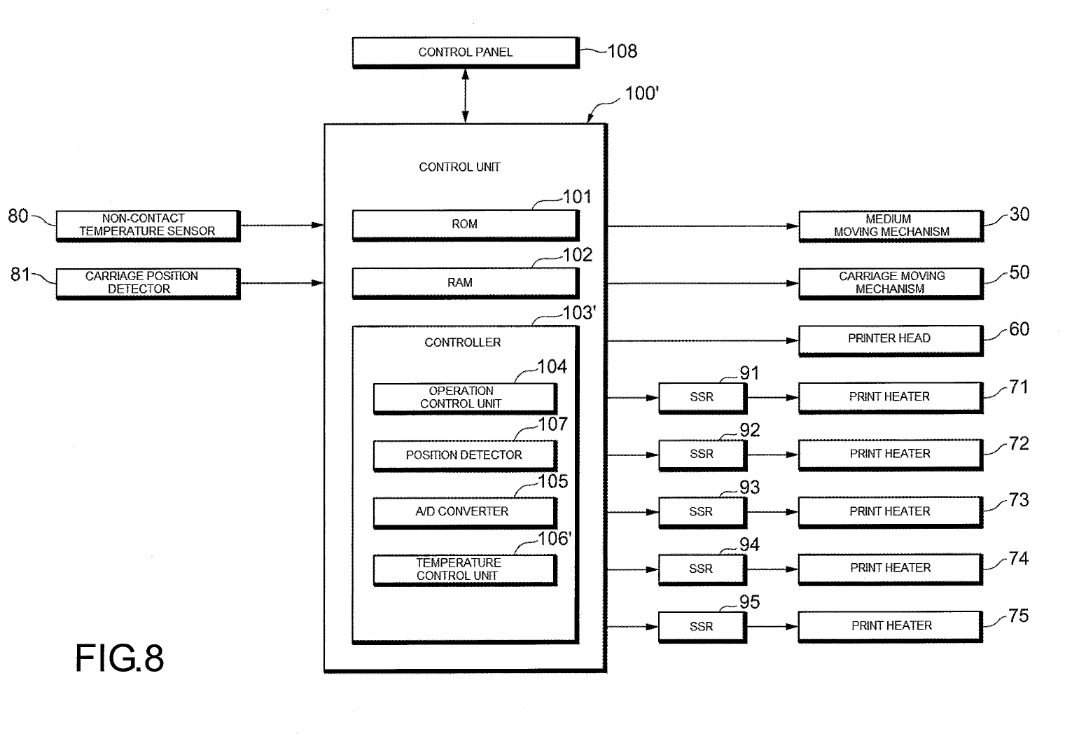

A carriage position detector 81 (see FIG. 8) that detects a scanning direction position (position in the horizontal direction) of the carriage 40 is provided on the back face of the carriage 40. Detection signals output from the carriage position detector 81 are sequentially output to the control unit 100′. Some examples of the carriage position detector 81 are a linear encoder, a rotary encoder, and the like.

As shown in FIG. 8, which is a schematic block diagram of the inkjet printer P′, a controller 103′ of the control unit 100′ includes a position detector 107 that detects a position of the non-contact temperature sensor 80 apart from the operation control unit 104, the A/D converter 105, and the temperature control unit 106′.

The position detector 107 calculates, in addition to detecting the scanning direction position of the carriage 40 based on detection signals input from the carriage position detector 81, a scanning direction position of the non-contact temperature sensor 80 that moves scanningly along with the carriage 40 based on the detected scanning direction position. The position (coordinates) of each of the print heaters 71 to 75 is stored in the RAM 102, and respective relative positions of the print heaters 71 to 75 with the non-contact temperature sensor 80 that vary according to the scanning movement of the carriage 40 are determined.

The temperature control unit 106′ determines a surface temperature distribution of the drawing area of the printing medium M, based on surface temperature information of the printing medium M input at very short time intervals from the non-contact temperature sensor 80 and position information of the non-contact temperature sensor 80 obtained from the position detector 107. Furthermore, based on the position (coordinates) of each of the print heaters 71 to 75 stored in the RAM 102, the temperature control unit 106′ calculates as detected temperatures Tm1 to Tm5 an average value (or maximum value or minimum value) of the surface temperature for each of the areas of the printing medium M corresponding to the arrangement of the print heaters 71 to 75 from the surface temperature distribution of the printing medium M, determines for each of the areas temperature deviations ΔT1 to ΔT5 (ΔTn=Ts−Tmn) from the setting temperature Ts already set in the RAM 102, and outputs driving signals corresponding to the temperature deviations ΔT1 to ΔT5 to the respective SSRs 91 to 95 of the respective print heaters 71 to 75.

By performing switch driving based on the driving signals (driving amounts corresponding to the temperature deviations ΔT1 to ΔT5) output from the temperature control unit 106′, the SSRs 91 to 95 switch the power supply to the respective print heaters 71 to 75 on or off, and exert control on the print heaters 71 to 75 so that the surface temperature of each of the areas on the printing medium M is at the optimum temperature (setting temperature Ts).

In this manner, the temperature control unit 106′ performs feedback control by switching the power supply to the print heaters 71 to 75 on or off via the SSRs 91 to 95 to adjust the surface temperature of each of the areas of the printing medium M corresponding to the heater arrangement to the optimum temperature (setting temperature Ts) (that is, to homogenize the surface temperature distribution of the printing medium M to the setting temperature Ts).

An overall structure of the inkjet printer P′ according to the second embodiment has been described above. Operations of the constituent components of the inkjet printer P′ by which desirable printing is carried out on the printing medium M are explained below.

During the printing operation of the inkjet printer P′, the non-contact temperature sensor 80 built integrally into the carriage 40 moves scanningly over the printing medium M and detects the infrared rays emanating from the printing medium M at very short time intervals, and sequentially outputs the detection signals corresponding to the strength of the detected infrared rays to the control unit 100′. The analog signals input from the non-contact temperature sensor 80 are converted into digital signals by the A/D converter 105 in the control unit 100′, and thereafter function-converted into the detected temperatures Tm1 to Tm5 of each area according to the heater arrangement by the temperature control unit 106′. The temperature control unit 106′ compares each of the measured detected temperatures Tm1 to Tm5 of the areas where measurement was done and the setting temperature Ts already stored in the RAM 102, and calculates the respective temperature deviations ΔT1 to ΔT5 thereof.

The temperature control unit 106′ then outputs the driving signals corresponding to the magnitudes of the temperature deviations ΔT1 to ΔT5 to the SSRs 91 to 95, and thereby controls the switching on or off of the power supply to the respective print heaters 71 to 75. When the power supply to any of the print heaters 71 to 75 is switched on, during the period in which power is supplied to that print heater 71 to 75, the area of the printing medium M corresponding to that print heater 71 to 75 gets heated up via the platen 20, and the surface temperature of the area of the printing medium M rises gradually. When the power supply is switched off, during the period in which power supply to the print heater 71 to 75 is cut off, no heating of the area of the printing medium M corresponding to the print heater 71 to 75 takes places, and the surface temperature of the area of the printing medium M gradually declines. Thus, by controlling the switching on or off of the power supply to the print heaters 71 to 75 according to the magnitude of the temperature deviations ΔT1 to ΔT5, the surface temperature of the printing medium M in the drawing area can be adjusted to the setting temperature Ts, and the surface temperature of the printing medium M across the entire drawing area (surface temperature distribution) can be homogenized to the optimum temperature.

Each time the non-contact temperature sensor 80 moves scanningly over the printing medium M along with the carriage 40, the surface temperature of the printing medium M in the area thereof that has been fed-forward by the predetermined pitch is also measured, and based on the temperature deviations ΔT1 to ΔT5, control of the switching on or off of the power supply to the print heaters 71 to 75 is performed so that the surface temperature of the printing medium M is adjusted to the setting temperature Ts. Therefore, even as the printing medium M is continually fed forward as the scanning movement of the carriage 40 is underway, the surface temperature of the printing medium M can be homogenized to the optimum temperature at all times.

The advantages of the inkjet printer P′ according to the second embodiment are summarized below. The inkjet printer P′ determines the temperature deviations ΔT1 to ΔT5 from the optimum temperature (setting temperature Ts) for each of the areas of the printing medium M corresponding to the arrangement of the print heaters 71 to 75, and performs feedback control by switching the power supply to the respective print heaters 71 to 75 on or off so that the surface temperature distribution across the entire surface of the printing medium M is homogenized to the optimum temperature. Because the fixability of the ink can be stabilized without any unevenness on the entire surface on which printing is to be performed by homogenizing the surface temperature across the entire drawing area of the printing medium M, the printing quality of the inkjet printer P′ can be improved.

In the first and second embodiments, the electric heaters (print heaters 70 and 71 to 75) are provided only in that part of the platen 20 that corresponds to the medium supporting unit 21 (that is, the main platen 22). However, an electric heater (pre-heater) can be provided, for example, on the back face of the rear platen 23 that extends backward from the main platen 22. With this structure, sudden temperature variation of the drawing area can be controlled by heating up the printing medium M before the commencement of drawing, and therefore the surface temperature of the drawing area of the printing medium M can be more easily adjusted to the optimum temperature. Furthermore, an electric heater (after-heater) can also be provided on the back face of the front platen 24 that extends forward from the main platen 22. With this structure, drying of the ink deposited on the printing medium M can be further speeded up, and thus improved printing quality can be further ensured.

### Third Embodiment

An inkjet printer P″ according to a third embodiment of the present invention is shown in FIGS. 1 and 2. The inkjet printer P″ has a structure that is substantially similar to those of the inkjet printers P and P′ according to the first and second embodiments, respectively. Only the aspects in which the inkjet printer P″ differs from the inkjet printers P and P′ are explained below. The constituent elements of the inkjet printer P″ that have been assigned the same reference numerals/symbols as for the inkjet printers P and P′ have the same structures explained in the first and second embodiments.

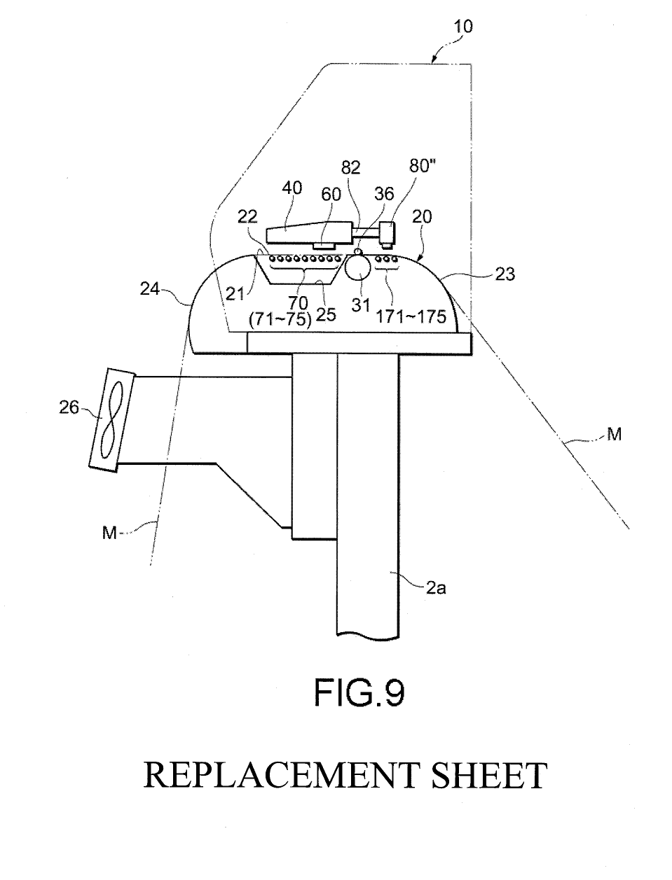

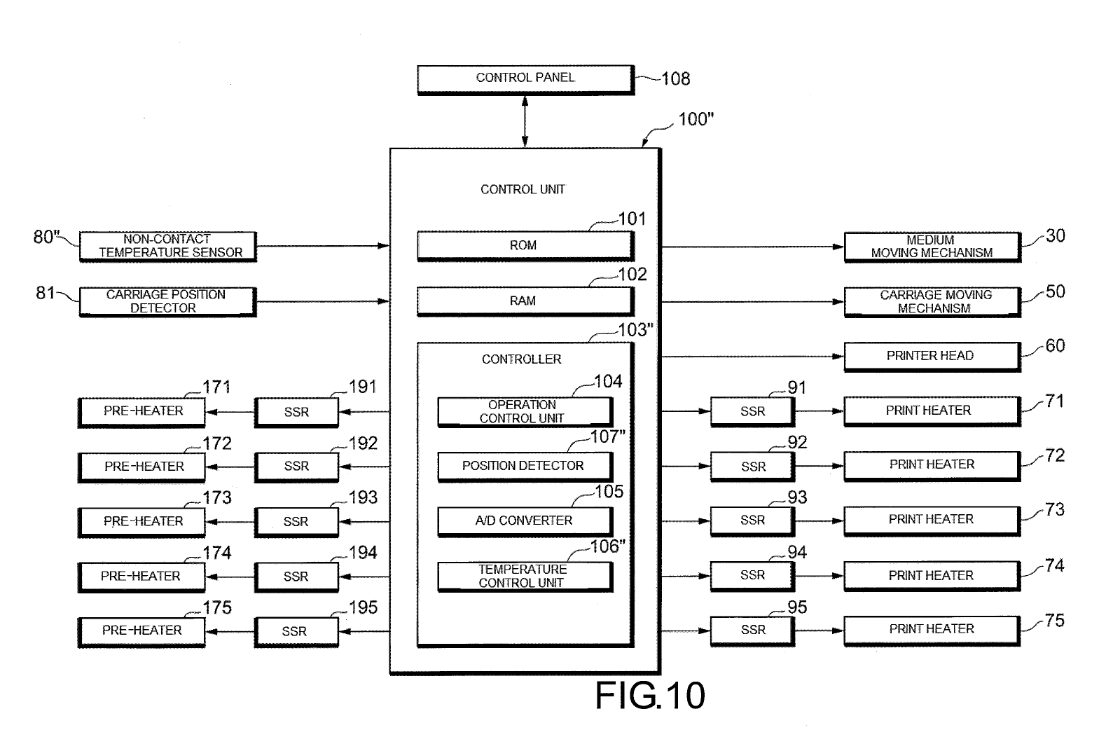

In the third embodiment, in addition to the print heaters 71 to 75 that are arranged in the scanning direction (horizontal direction) of the carriage 40 on the back face of the main platen 22 that supports the printing medium M similar to the second embodiment, a plurality of pre-heaters 171 to 175 is arranged in a direction parallel to the scanning direction of the carriage 40 on the back face of the rear platen 23 that extends backward from the main platen 22 (see FIGS. 9 and 10). The print heaters 71 to 75 and the pre-heaters 171 to 175 are arranged facing each other in an antero-posterior direction with a one-to-one relation between them. In response to a command from a temperature control unit 106″ of a control unit 100″, the power supply to each of the print heaters 71 to 75 and the pre-heaters 171 to 175 is controlled so as to be independently switched on or off via a corresponding one of the SSRs 91 to 95 and SSRs 191 to 195. In the following explanation, an area of the printing medium M that is heated up by the pre-heaters 171 to 175 is referred to as an upstream area, and an area heated up by the print heaters 71 to 75 is referred to as the drawing area.

As shown in FIG. 9, a non-contact temperature sensor 80″, which is mounted on an arm unit 81 that extends backward from the carriage 40, is arranged above the rear platen 23 so as to be able to measure the surface temperature of the portion of the printing medium M over the pre-heaters 171 to 175 (that is, the upstream area of the printing medium M). With the scanning movement of the carriage moving mechanism 50, the non-contact temperature sensor 80″ detects the infrared rays emanating from the upstream area of the printing medium M at very short time intervals, and outputs analog voltage signals corresponding to a strength of the detected infrared rays to the control unit 100″.

As shown in the schematic block diagram of the inkjet printer P″ in FIG. 10, a controller 103″ of the control unit 100″ includes the operation control unit 104, the A/D converter 105, the temperature control unit 106″, and a position detector 107″.

The position detector 107″ calculates, in addition to detecting the scanning direction position of the carriage 40 based on the detection signals input from the carriage position detector 81, a scanning direction position of the non-contact temperature sensor 80″ that moves scanningly along with the carriage 40 based on the detected scanning direction position. The position (coordinates) of each of the pre-heaters 171 to 175 is stored in the RAM 102, and respective relative positions of the pre-heaters 171 to 175 with the non-contact temperature sensor 80″ that vary according to the scanning movement of the carriage 40 are determined.

The temperature control unit 106″ determines a surface temperature distribution of the upstream area of the printing medium M, based on the surface temperature information of the upstream area of the printing medium M input from the non-contact temperature sensor 80″ and position information of the non-contact temperature sensor 80″ obtained from the position detector 107″, and outputs driving signals corresponding to the surface temperature distribution to the SSRs 191 to 195 so that the surface temperature distribution is homogenized to the setting temperature stored in the RAM 102.

On the other hand, the temperature control unit 106″ reads the printing computer program stored in the RAM 102 and refers to image data corresponding to the upstream area, and when the upstream area is fed up to the drawing area on the main platen 22 by the medium moving mechanism 30, outputs driving signals obtained by adding a predetermined heating amount ΔTu to the setting temperature Ts to the SSRs 191 to 195 corresponding to the pre-heaters 171 to 175 that heat up the upstream area, for the upstream area where a discharge amount of the ink that will be deposited exceeds a predetermined threshold value already set in the printer heads 60. If the upstream area of the printing medium M (the portion where an ink discharge amount exceeds the threshold value) cannot be heated up by the required pre-warming amount by operating the pre-heaters 171 to 175 to perform heating to the setting temperature Ts set in the RAM 102, an appropriate heating amount ΔTu corresponding to the ink discharge amount, which is already stored in a table (internal memory of the controller 103″), is read from the table by the temperature control unit 106.

By performing switch driving based on the driving signals output from the temperature control unit 106″, the SSRs 191 to 195 switch the power supply to the respective pre-heaters 171 to 175 on or off, and exert control over the driving of the pre-heaters 171 to 175 by switching the power supply to the pre-heaters 171 to 175 on or off so that the surface temperature of the portion of the upstream area of the printing medium M where the discharge amount of the ink that will be deposited will be below the predetermined threshold value is at the setting temperature Ts stored in the RAM 102, and the surface temperature of the portion of the upstream area of the printing medium M where the discharge amount of the ink that will be deposited will exceed the predetermined threshold value is at a temperature obtained by adding the heating amount ΔTu to the setting temperature Ts.

The advantages of the inkjet printer P″ according to the third embodiment are summarized below. In the inkjet printer P″, before the printing medium M is fed to the drawing area, the surface temperature of the upstream area where the discharge amount of the ink that will be deposited is dropped below the predetermined threshold value as per the setting in the printer heads 60 is adjusted to the setting temperature Ts (which, for example, is a relatively low temperature) by the pre-heaters, and the surface temperature of the upstream area where the discharge amount of the ink that will be deposited will exceed the predetermined threshold value as per the setting in the printer heads 60 is adjusted to the temperature obtained by adding the heating amount ΔTu to the setting temperature Ts by the pre-heaters. Consequently, in the portions of the printing medium M where an ink deposition amount is more, the ink is quickly fixed and dried, and thereby high quality printing and better productivity can be realized. Furthermore, by pre-heating the printing medium M by the heating amount according to the ink discharge amount (ink deposition amount), the setting temperature Ts of the portion of the printing medium M where the ink discharge amount (ink deposition amount) is less can be kept relatively low. Consequently, energy saving can be realized by reducing power consumption.

Because the heating amount ΔTu depends upon the ambient temperature, an ambient temperature detector (temperature sensor), for example, is separately provided, so that an appropriate heating amount ΔTu according to the detected ambient temperature is read from the table. A time period t required for heating depends on and is controlled by a printing time per line (carriage movement time) tc, a printing band width (width of the drawing area) W, a feed time th of the printing medium M, etc. (tc, W, and th are constants used for deriving the heating time t).

The non-contact temperature sensor (the temperature sensor 80 in the second embodiment) that measures the surface temperature of the drawing area on the printing medium M can be provided in conjunction with the carriage 40, and the driving of the print heaters 71 to 75 can be controlled in conjunction via the SSRs 91 to 95 so that the heating amount of the print heaters 71 to 75 is increased for the drawing area where the discharge amount of the ink that is deposited thereon exceeds the threshold value will be more based on the image data.

A non-contact temperature sensor can be provided to detect the surface temperature of the printing medium M in a downstream area located over the front platen 24. In such a structure, in the portion of the downstream area where the temperature detected by the non-contact temperature sensor is low, it can be presumed that the ink discharge amount (that is, the ink deposition amount) is more in the portion and that the cause of the low surface temperature is due to heat dissipation caused by evaporation, etc., of the ink. Therefore, to prevent drying failure of the ink droplets deposited in the area, control can be exerted so that the heating amount of the pre-heaters 171 to 175 and the print heaters 71 to 75 to the upstream area and the drawing area corresponding to the downstream area when the temperature is low can be increased.

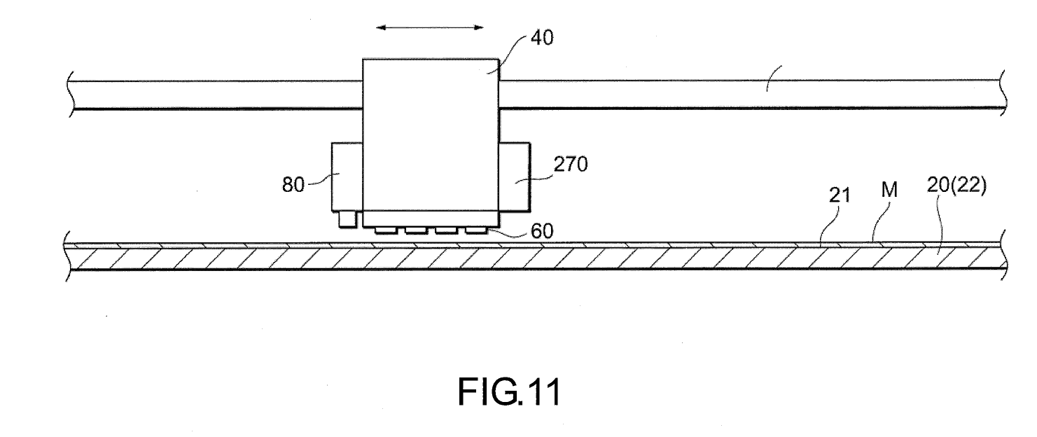

Although the preferred embodiments of the present invention are described here, the present invention is not to be thus limited. For example, in the first to third embodiments, a so-called platen heater is built into the platen 20 as a heater unit for heating up the printing medium M. However, the heater unit can be provided above the platen 20 so as to directly heat up the surface of the printing medium M. For example, as shown in FIG. 11, a heater unit 270 is mounted on the carriage 40 so that the heater unit 270 also moves over the printing medium M along with the carriage 40. According to this structure, energy saving can be realized by controlling the overall power consumption of the inkjet printer because only the required areas of the printing medium M (areas where the ink is deposited) are heated up. Although not illustrated, the heater unit can be provided on a sliding member that is slidable back and forth on a separate rail member provided above the printing medium M extending parallel to (in a horizontal direction) the guide rail 45. According to this structure also, energy saving can be realized by controlling the overall power consumption of the inkjet printer because only the required areas of the printing medium M (areas where the ink is deposited) are heated up. Furthermore, a heater unit that covers substantially the entire drawing area of the printing medium M can be provided on the rail member that extends parallel to the guide rail 45. According to this structure, a mechanical configuration can be simplified by providing an immobile heater unit.

Moreover, in the first to third embodiments, the heater unit that heats up the printing medium M is assumed to be an electric heater. However, the heater unit can be a high-frequency apparatus (magnetron) that supplies high frequencies via a waveguide, a far-infrared heater, or the like.

In the first to third embodiments, the print heaters 71 to 75 are arranged along the scanning direction of the carriage 40. However, a single print heater can be provided which can perform adjustment of the driving amount (output) of the printing medium M, which is segmented along the scanning direction of the carriage 40 into a plurality of areas, area by area.

Furthermore, in the embodiments explained above, the inkjet printer is assumed to be a uniaxial printing medium movement, uniaxial printer head movement type inkjet printer. The present invention, however, can be applied to other inkjet printer, for example, a biaxial printer head movement type inkjet printer.

### EXPLANATIONS OF LETTERS OR NUMERALS

M: Printing medium

P, P′, and P″: Inkjet printer

20: Platen (medium supporting unit)

40: Carriage

50: Carriage moving mechanism

60: Printer head

70: Print heater (Heater unit)

71 to 75: Print heater (Heater unit, Segmented heater unit)

171 to 175: Pre-heater (Heater unit, Segmented heater unit)

80 and 80″: Non-contact temperature sensor (Temperature detecting unit)

90: SSR (Temperature control unit)

91 to 95: SSR (Temperature control unit)

100, 100′, and 100″: Control unit

106, 106′, and 106″: Temperature control unit (Temperature control unit)

191 to 195: SSR (Temperature control unit)

270: Heater unit

1. An inkjet printer comprising:
a medium supporting unit that supports a printing medium;
a carriage that includes a printer head that discharges ink;
a carriage moving mechanism that moves the carriage relative to the printing medium supported by the medium supporting unit along a printing surface thereof;
a heater unit that performs heating temperature control of the printing medium;
a temperature detecting unit that is mounted on the carriage facing the printing surface and that detects a surface temperature of the printing medium along a relative movement direction with the relative movement of the carriage; and
a temperature control unit that exerts control to adjust the surface temperature of the printing medium to a predetermined setting temperature by driving the heater unit based on a detected temperature detected by the temperature detecting unit.

2. The inkjet printer according to claim 1, wherein
the heater unit includes a plurality of segment heater units that performs heating temperature control of the printing medium, which is segmented into a plurality of segmented areas along the relative movement direction, segmented area by segmented area, and
the temperature control unit drives an appropriate segment heater unit based on the detected temperature detected segmented area by segmented area by the temperature detecting unit along the relative movement direction, and exerts control to homogenize the surface temperature of the printing medium to a predetermined setting temperature.

3. The inkjet printer according to claim 2, wherein the temperature control unit exerts control to adjust the surface temperature of a segmented areas where a discharge amount of the ink deposited thereon exceeds a predetermined threshold value set in the printer head to a temperature obtained by adding a heating amount according to the discharge amount to the predetermined setting temperature.
